(19) United States
(12) Patent Application Publication
(10) Pub. No.: US 2006/0140203 A1
(43) Pub. Date: Jun. 29, 2006

(54) System and method for packet queuing

(76) Inventors: Sanjeev Jain, Shresbury, MA (US); Gilbert M. Wolrich, Framingham, MA (US); Mark B. Rosenbluth, Uxbridge, MA (US); Debra Bernstein, Sudbury, MA (US)

Correspondence Address: Daly, Crowley & Mofford, LLP;PortfolioIP, P.O. Box 52050, Minneapolis, MN, 55402, US

(21) Appl. No.: 11/026,313

(22) Filed: Dec. 28, 2004

(51) Int. Cl. H04L 12/28

(52) U.S. Cl. 370/412

(57) ABSTRACT

Data is enqueued and dequeued using a block-based queuing structure.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, network devices, such as routers and switches, can include network processors to facilitate receiving and transmitting data. In certain network processors, such as multi-core, single die IXP Network Processors by Intel Corporation, high-speed queuing and FIFO (First In First Out) structures are supported by a descriptor structure that utilizes pointers to memory. U.S. patent application Publication No. 2003/0140196 A1 discloses exemplary queue control data structures.

Network processors can enqueue data received as packets and then retransmit the data as fixed sized segments into a switching fabric or ATM (Asynchronous Transfer Mode) media. However, enqueuing queuing and dequeuing packets to a single queue at relatively high line rates, such as OC-192 (10 Gbps), for minimum size POS (Packet Over SONET (Synchronous Optical Network)) packets can be difficult.

### BRIEF DESCRIPTION OF THE DRAWINGS

The exemplary embodiments contained herein will be more fully understood from the following detailed description taken in conjunction with the accompanying drawings, in which:

FIG. 1 is a diagram of an exemplary system including a network device having a network processor unit with a mechanism to avoid memory back conflicts when accessing queue descriptors;

FIG. 2 is a diagram of an exemplary network processor having processing elements with a conflict-avoiding queue descriptor structure;

FIG. 3 is a diagram of an exemplary processing element (PE) that runs microcode;

FIG. 4 is a diagram showing an exemplary data queuing implementation;

FIG. 5 is a schematic depiction of an exemplary block-based queuing structure;

FIG. 5A is a schematic depiction of a segmented data buffer;

FIG. 6 is a schematic depiction of a block-based queuing structure having linked blocks; and

FIG. 7 is a schematic depiction of enqueuing of a multi-buffer packet in packet mode.

### DETAILED DESCRIPTION

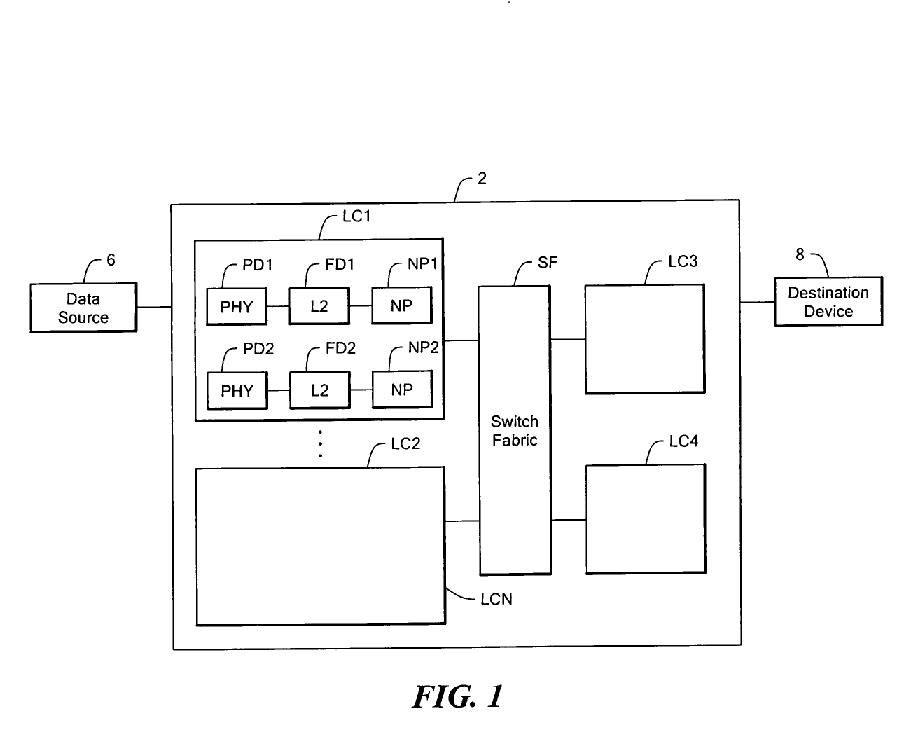

FIG. 1 shows an exemplary network device 2 having network processor units (NPUs) utilizing queue control structures with efficient memory accesses when processing incoming packets from a data source 6 and transmitting the processed data to a destination device 8. The network device 2 can include, for example, a router, a switch, and the like. The data source 6 and destination device 8 can include various network devices now known, or yet to be developed, that can be connected over a communication path, such as an optical path having a OC-192 line speed.

The illustrated network device 2 can manage queues and access memory as described in detail below. The device 2 features a collection of line cards LC1-LC4 (“blades”) interconnected by a switch fabric SF (e.g., a crossbar or shared memory switch fabric). The switch fabric SF, for example, may conform to CSIX (Common Switch Interface) or other fabric technologies such as HyperTransport, Infiniband, PCI (Peripheral Component Interconnect), Packet-Over-SONET (Synchronous Optic Network), RapidIO, and/or UTOPIA (Universal Test and Operations PHY Interface for ATM (Asynchronous Transfer Mode)).

Individual line cards (e.g., LC1) may include one or more physical layer (PHY) devices PD1, PD2 (e.g., optic, wire, and wireless PHYs) that handle communication over network connections. The PHYs PD translate between the physical signals carried by different network mediums and the bits (e.g., “0”-s and “1”-s) used by digital systems. The line cards LC may also include framer devices (e.g., Ethernet, Synchronous Optic Network (SONET), High-Level Data Link (HDLC) framers or other “layer 2” devices) FD1, FD2 that can perform operations on frames such as error detection and/or correction. The line cards LC shown may also include one or more network processors NP1, NP2 that perform packet processing operations for packets received via the PHY(s) and direct the packets, via the switch fabric SF, to a line card LC providing an egress interface to forward the packet. Potentially, the network processor(s) NP may perform “layer 2” duties instead of the framer devices FD.

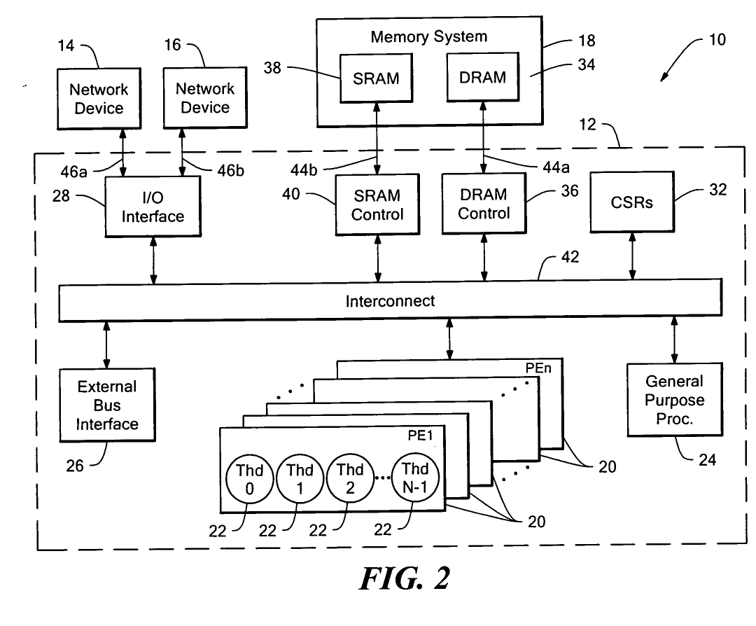

FIG. 2 shows an exemplary system 10 including a processor 12, which can be provided as a network processor having multiple cores on a single die. The processor 12 is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22, as will be described more fully below. In the described embodiment, the maximum number “N” of threads supported by the hardware is eight. Each of the processing elements 20 is connected to and can communicate with adjacent processing elements.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, and so forth.

The devices 14, 16 can be any network devices capable of transmitting and/or receiving network traffic data, such as framing/MAC (Media Access Control) devices, e.g., for connecting to 10/100BaseT Ethernet, Gigabit Ethernet, ATM (Asynchronous Transfer Mode) or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also be serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The 1/0 Interface 28 is coupled to the devices 14 and 16 via separate I/O bus lines 46a and 46b, respectively.

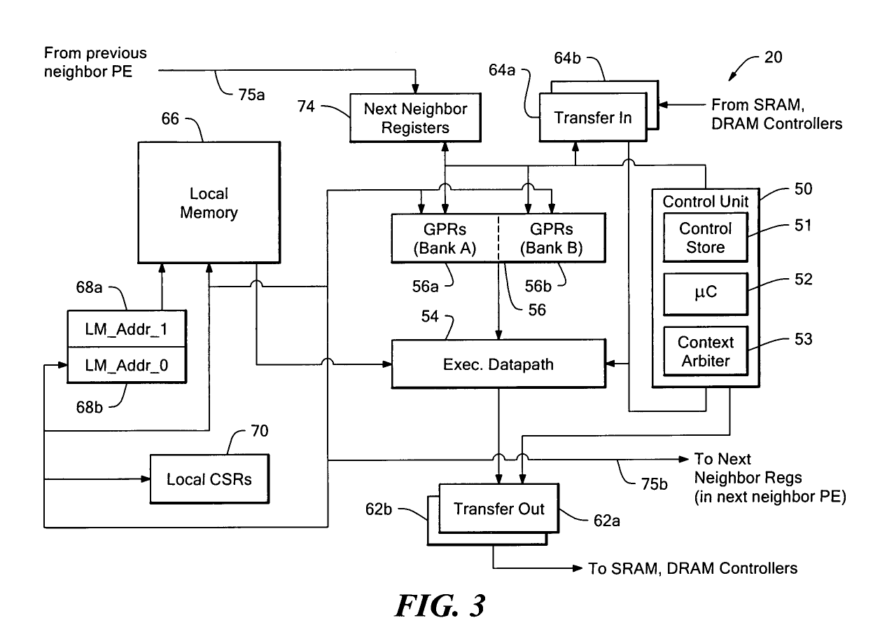

Referring to FIG. 3, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU, a multiplier and a Content Addressable Memory (CAM).

The registers of the GPR file unit 56 (GPRs) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes a write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_{—}1”), 68b (“LM_Addr_{—}0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

While illustrative hardware is shown and described herein in some detail, it is understood that the exemplary embodiments shown and described herein for efficient memory access for queue control structures are applicable to a variety of hardware, processors, architectures, devices, development systems/tools and the like.

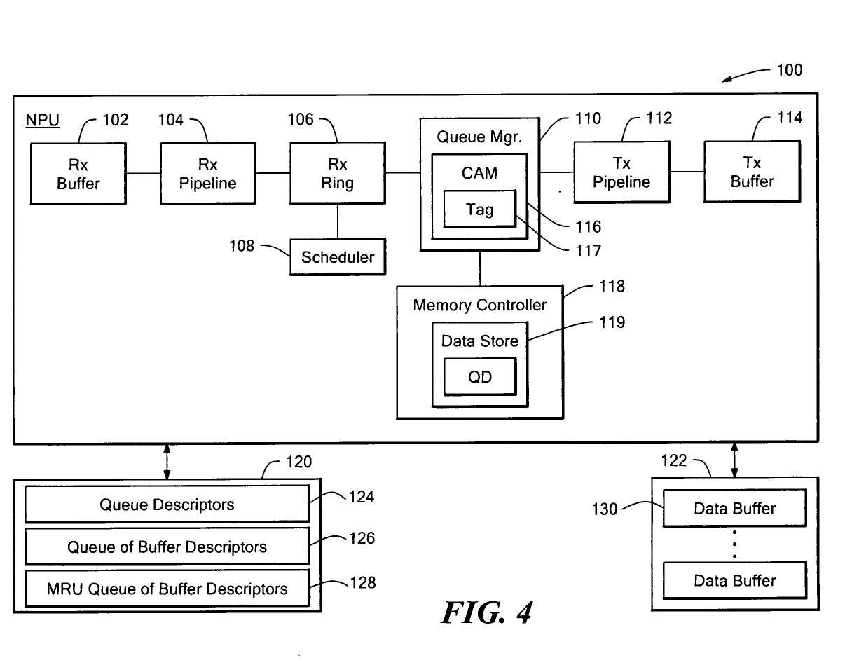

FIG. 4 shows an exemplary NPU 100 receiving incoming data and transmitting the processed data with efficient access of queue data control structures. As described above, processing elements in the NPU 100 can perform various functions. In the illustrated embodiment, the NPU 100 includes a receive buffer 102 providing data to a receive pipeline 104 that sends data to a receive ring 106, which may have a first-in-first-out (FIFO) data structure, under the control of a scheduler 108. A queue manager 110 receives data from the ring 106 and ultimately provides queued data to a transmit pipeline 112 and transmit buffer 114. The queue manager 110 includes a content addressable memory (CAM) 116 having a tag area to maintain a list 117 of tags each of which points to a corresponding entry in a data store portion 119 of a memory controller 118. In one embodiment, each processing element includes a CAM to cache a predetermined number, e.g., sixteen, of the most recently used queue (MRU) descriptors. The memory controller 118 communicates with the first and second memories 120, 122 to process queue commands and exchange data with the queue manager 110. The data store portion 119 contains cached queue descriptors, to which the CAM tags 117 point.

The first memory 120 can store queue descriptors 124, a queue of buffer descriptors 126, and a list of MRU (Most Recently Used) queue of buffer descriptors 128 and the second memory 122 can store processed data in data buffers 130, as described more fully below. The stored queue descriptors 124 can be assigned a unique identifier and can include pointers to a corresponding queue of buffer descriptors 126. Each queue of buffer descriptors 126 can includes pointers to the corresponding data buffers 130 in the second memory 122.

While first and second memories 120, 122 are shown, it is understood that a single memory can be used to perform the functions of the first and second memories. In addition, while the first and second memories are shown being external to the NPU, in other embodiments the first memory and/or the second memory can be internal to the NPU.

The receive buffer 102 buffers data packets each of which can contain payload data and overhead data, which can include the network address of the data source and the network address of the data destination. The receive pipeline 104 processes the data packets from the receive buffer 102 and stores the data packets in data buffers 130 in the second memory 122. The receive pipeline 104 sends requests to the queue manager 110 through the receive ring 106 to append a buffer to the end of a queue after processing the packets. Exemplary processing includes receiving, classifying, and storing packets on an output queue based on the classification.

An enqueue request represents a request to add a buffer descriptor that describes a newly received buffer to the queue of buffer descriptors 126 in the first memory 120. The receive pipeline 104 can buffer several packets before generating an enqueue request.

The scheduler 108 generates dequeue requests when, for example, the number of buffers in a particular queue of buffers reaches a predetermined level. A dequeue request represents a request to remove the first buffer descriptor. The scheduler 108 also may include scheduling algorithms for generating dequeue requests such as “round robin”, priority-based, or other scheduling algorithms. The queue manager 110, which can be implemented in one or more processing elements, processes enqueue requests from the receive pipeline 104 and dequeue requests from the scheduler 108.

In accordance with exemplary embodiments, a block-based data queuing structure enables enqueue of packets to a single queue and dequeue of segments from the queue to be executed at relatively high, e.g., OC-192, line rates for minimum size POS received packets. Relatively small fixed-size FIFO blocks can be used with the last entry of a block serving as the link to additional blocks. This arrangement allows back-to-back segment dequeue at OC-192 line rates while maintaining the flexibility to dynamically allocate memory resources.

Network processors typically us linked list or FIFO data structures to enqueue packets and output segments. For multi-buffer packets that are dequeued one segment or one buffer at a time, the block containing the last buffer of the multi-buffer packet becomes the new tail of queue.

In general, buffer descriptor pointers are written in a block at sequential locations. In one embodiment, the block size is configurable in a range from 8 block locations to 32 block locations, for example. The block size can be selected based upon various factors including link penalty. Since the last location of the block identifies a link to the next block, this location does not store a buffer descriptor and, therefore, is overhead. For a block with 8 entries, this overhead is 12.5% (⅛).

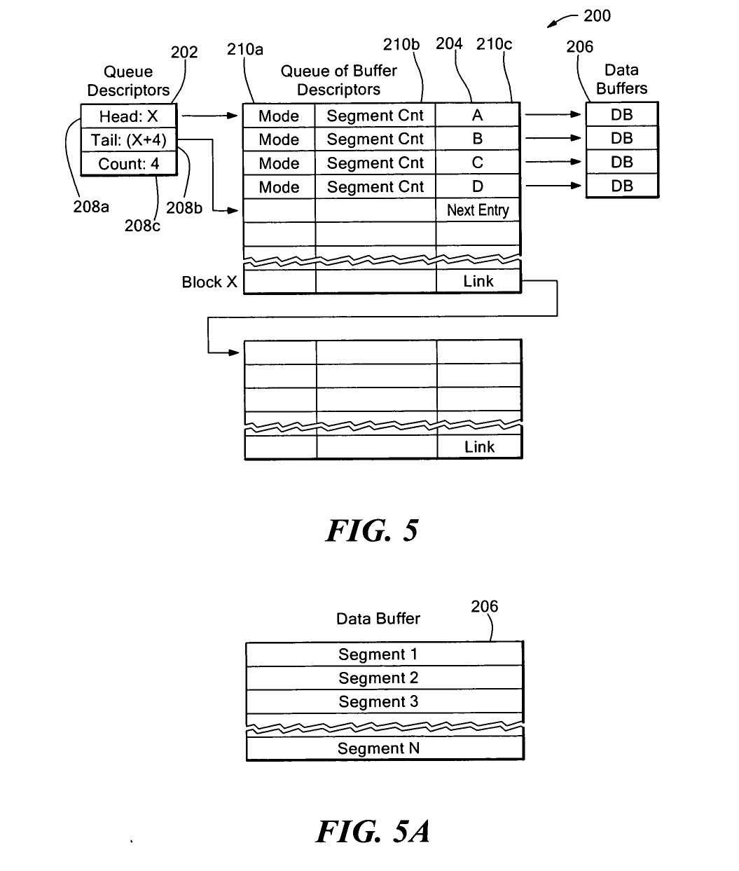

FIG. 5 shows an exemplary block-based queuing structure 200 enabling packets to be dequeued as fixed size segments. More particularly, FIG. 5 shows single buffer packets being enqueued to a fixed-size block. The queuing structure includes a queue descriptor 202, blocks of queue buffer descriptors 204, and data buffers 206. The queue descriptor 202 includes a head pointer field 208a, a tail pointer field 208b, and a count 208c of associated buffers. The head pointer 208a of the queue descriptor points to the next entry in the block to be removed from the queue and the tail pointer 208b points to the entry in the block where a new buffer descriptor is to be added to the end of the queue. The queue of buffer descriptors 204 includes a mode descriptor field 210a, a segment count field 210b, and a data buffer pointer field 210c.

In one particular embodiment, a buffer descriptor for segment dequeue has the following configuration:

| | |
|---|---|
| Bits 31:29 | Mode Descriptor |
| Bits 28:24 | Segment count |
| Bits 23:0 | Data buffer pointer |

While shown as having 32 bits, it is understood that any number of bits can be used and the partition into various fields can be readily modified to meet the needs of a particular application. It is further understood that while illustrative embodiments show head and tail pointers, other pointer structures can be used.

The mode descriptor field 210a defines properties of current buffer. Illustrative properties include SOP (start of packet), EOP (end of packet), Last Segment, Split/Not Split etc. The segment count 210b defines number of fixed size segments in the current buffer. And the data buffer pointer 210c points to the starting address of the data buffer 206 where data is stored. If all buffers are same size, then this pointer may not need to store the lower significant bits of the address. For example if the buffer size is 256 bytes, bits [7:0] will be zero for the data buffer address and need not be stored. In this case, the data buffer pointer will contain bits [31:8] resulting in up to 4 GB of addressing capability.

In the illustrative embodiment of FIG. 5, the head pointer 208a points to a first block 204, which can be referred to as block X. The tail pointer 208b points to the next entry after the last buffer descriptor in block X. In the last entry of block X in the data buffer field 210c there is a link to the next block, shown as block Y. In one embodiment, the last entry in each block (except the last block) contains a link to the next block. Each data buffer pointer 210c points to a respective data buffer. As shown in FIG. 5A, the data in the data buffer 206 can be segmented into fixed size segments, seg 1, seg 2, seg 3, . . . , seg N, in a manner well known to one of ordinary skill in the art.

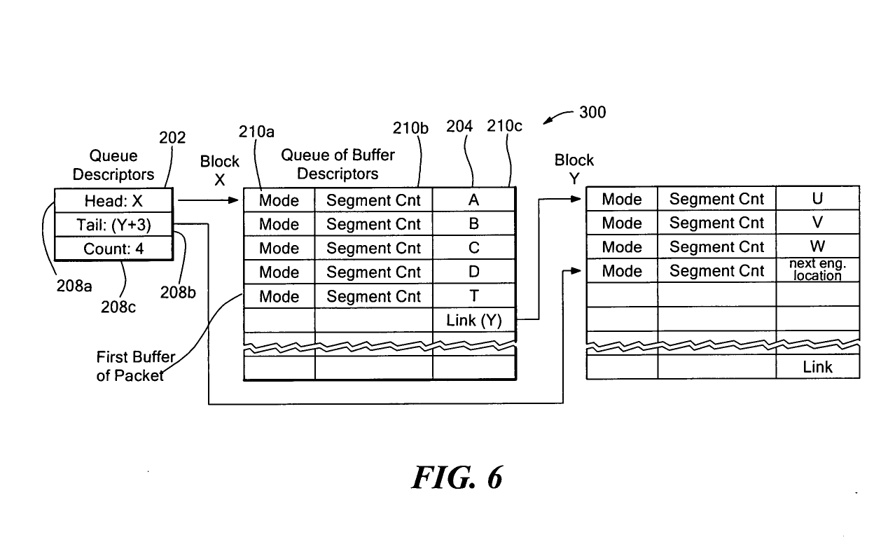

FIG. 6 shows a queuing structure 300 for enqueing of a multi-buffer packet using block-based queuing. The structure 300 of FIG. 6 has certain features in common with the structure 200 of FIG. 200 for which like reference numbers indicate like reference elements. The head pointer 208a points to block X and the tail pointer 208b points to the next enqueue location, e.g., Y+3, in block Y. The count field 208c contains four since there are 4 buffers required for the current packet. Data buffer pointers 210c A, B, C, D, and T are stored in the block X with a link to block Y stored in the entry in block X after T. The first buffer pointer T of the packet is stored in block X and the next buffer pointers U, V, W for the packet are stored in block Y, as described more fully below.

In general, block-based queuing for packets can be divided in six categories.
1. Enqueue a single buffer packet in segment mode
2. Enqueue a Multi-buffer packet in segment mode
3. Dequeue a single buffer packet in segment mode
4. Dequeue a multi-buffer packet in segment mode
5. De-queue a single buffer packet in Buffer Mode
6. De-queue a multi-buffer packet in Buffer Mode

To enqueue a single buffer packet in segment mode (FIG. 5), the PE that executes an enqueue command sends the following information to the queuing hardware (QH), such as the queue manager 110 of FIG. 4:
queue number
buffer descriptor
new block address
   Based on the queue number, the queue hardware reads the queue descriptor 202 (head pointer 208a, tail pointer 208b) from memory. When the queue hardware receives the queue descriptor 202 data, if the tail pointer 208a is not indexing the last entry of a block, the queue hardware writes the buffer descriptor pointer to the tail pointer 208b address, and then increments tail pointer. If the tail pointer 208b is at the last entry of a block, the queue hardware uses the block address received with the command and writes its address into the link location and then writes the buffer descriptor 204 at the first location of the new block. The tail pointer 208b is then incremented to the next (second) location in this new block. A signal is sent to the queuing ME to notify it that the block supplied with the command has been used.

To enqueue a multi-buffer packet in segment mode (FIG. 6), the PE that executes the multi-buffer enqueue sends the following information to the queuing hardware:
Multi-buffer Enqueue Command
Queue number
First Buffer descriptor
Subsequent block address for additional buffer descriptors
Last buffer descriptor location in the subsequent block.
A new block address

Based on the queue number, queuing hardware reads the queue descriptor (head pointer 208a, tail pointer 208b) from memory. After the queue descriptor 204 is received, at the address pointed to by the tail pointer 208b the queue hardware writes the received first buffer descriptor to external memory and in the next location writes the subsequent block address for the next entry. If the tail pointer 208b is pointing to the last location of the block, the queue hardware uses the block address received with the command and writes its address in the link location and then writes the first buffer descriptor at the first location of the new block, e.g., block Y, and in the next location writes the subsequent block address. The tail pointer 208b then points to the next location of the last buffer descriptor location in the subsequent block. A signal is sent to the queuing PE to notify it that the new block supplied with the command has been used.

To dequeue a single buffer packet in segment mode, the PE that executes the dequeue sends the queue number in the dequeue command. The queue hardware reads the queue descriptor 202 from memory. Using the head pointer 208b, the queue hardware then launches a read of the buffer descriptor 204 pointed to by the head pointer 208a. For dequeue requests to the same queue before the first buffer descriptor read is complete, the queue hardware can launch a memory read for the next buffer descriptor in the block.

When the initial buffer descriptor read completes, the queue hardware executes a “Segment Dequeue” by decrementing the segment count 210b and sending the buffer descriptor 204 with decremented segment count to the PE. Segments, such as the segments seg1, seg2, seg3, . . . , segN, in FIG. 5A, can be dequeued from the data buffer for each segment dequeue command. If subsequent dequeue requests are satisfied by this buffer descriptor because the remaining segment count is non zero (there are still segments in the data buffer), the pre-fetched buffer descriptor for the next dequeue request is discarded and the buffer descriptor is sent to the PE with the segment count 210b again decremented. That is, segments are dequeued and the segment count 210b is decremented in the queue descriptor. Thus, a back-to-back dequeue sequence from the same queue works with the same efficiency as the non back-to-back dequeues.

The queuing hardware can also dequeue a multi-buffer packet in segment mode. Block based queuing embodiments described herein work well in both so called burst-of-2 and burst-of-4 modes for memory operations. The first buffer descriptor and link address, e.g., T and link (Y) in FIG. 6, for a multi-buffer packet in burst-of-4 memories is written to the current block at a quad-word aligned address. So the first buffer descriptor and link address are available in one read. Dequeue from a multi-buffer packet works basically the same way as dequeue from a single buffer packet. When the first buffer (T) of a multi-buffer packet is consumed, the link (Y) written in the next location is used and the next buffer descriptor (U) from the linked block is read when servicing the follow on dequeue requests for the same queue.

To dequeue a single buffer packet in buffer mode, the queuing hardware does not look at segment count field 210b and dequeues the entire buffer at a time. Since the segment count field is ignored by the queuing hardware, the segment count bits can be used by software to store the packet length. Since there are only few bits available to store the packet length in this mode, the length can be in relatively course granularity. To operate in this mode, the PE can issue “Dequeue Buffer” command in place of a “Dequeue Segment” command.

A multi-buffer packet can be dequeued in Buffer Mode. When a multi-buffer packet is enqueued in segment mode, and is de-queued in buffer mode, the packet length is stored in segment count field of the first buffer descriptor (T)+bits [27:21] of the link. The queuing hardware returns the buffer descriptor 204 along with the packet length to the PE for the first dequeue command. On a subsequent dequeue of this multi-buffer packet, only the buffer descriptor is returned.

Since multiple buffer descriptor reads can be launched in parallel, the bottleneck experienced in previous queuing structure is reduced or eliminated. In addition, the exemplary queuing structures are compatible with burst-of-4 memory architectures. Further, the queuing structures provide segment queue support that scales with new memory technologies and is latency tolerant. It also supports ECC (Error Correction Code) for queue descriptors and data descriptors.

In further exemplary embodiments, a block-based queuing structure includes a buffer descriptor format having a packet length. In one particular embodiment, a data structure for a single buffer packet includes the following fields:

| | |
|---|---|
| Bits 31:30 | Mode Descriptor |
| Bits 29:24 | Packet Length in software defined granularity |
| Bits 23:0 | Data buffer pointer |

The mode descriptor defines the properties of current buffer, such as SOP, EOP, single buffer packet/multi-buffer packet etc. The packet length defines the length of the single buffer packet. And the data buffer pointer points to the starting address of the data buffer where actual data is stored. If all buffers are same size, then this pointer may not need to store the lower significant bits of the address, as noted above.

An exemplary data structure for multi-buffer packets includes first 32-bit word (LWO) and a second 32-bit word (LW1):

| | | |
|---|---|---|
| LW0 | Bits 31:30 | Mode Descriptor → Indicates multi-buffer packet |
| | Bits 29:16 | Software defined |
| | Bits 15:0 | Packet length |
| LW1 | Bits 31:30 | Mode descriptor → Indicates Link |
| | Bits 29:21 | Software defined |
| | Bits 20:0 | Link block address |

As set forth above, the mode descriptor defines the properties of current buffer and the Packet Length defines length of the multi-buffer packet. The link block address points to the starting address of the attached block where packet buffer descriptors are stored.

As described above, a queue descriptor contains a head pointer pointing to the next head entry in the current block and a tail pointer pointing to the location where the newly enqueued buffer descriptor will be written.

Packet dequeuing using block-based queuing can be divided into four major categories:
Enqueue a single buffer packet in packet mode
Enqueue a Multi-buffer packet in packet mode
Dequeue a single buffer packet in packet mode
Dequeue a multi-buffer packet in packet mode

Enqueue of a single buffer packet in packet mode is similar to that shown in FIG. 5. The PE executing an enqueue command sends the following information to the queuing hardware:
Queue number
Buffer descriptor ([31:30]: Mode selector, [29:24]: Packet length, [23:0]: Buffer pointer
A new block address
   Based on the queue number, the queuing hardware reads the queue descriptor (head pointer 208a, tail pointer 208b) from memory. After the queue descriptor 202 is returned, at the address pointed to by the tail pointer 208b, the queuing hardware writes the received buffer descriptor 204 to external memory. If the tail pointer is pointing to the last location of the block, the queuing hardware uses the block address received with the command and writes its address in the link location and then writes the buffer descriptor at the first location of the new block. The tail pointer 208b moves to the next location in this new block. A signal is sent to the queuing PE for notification that the block supplied with the command has been used.

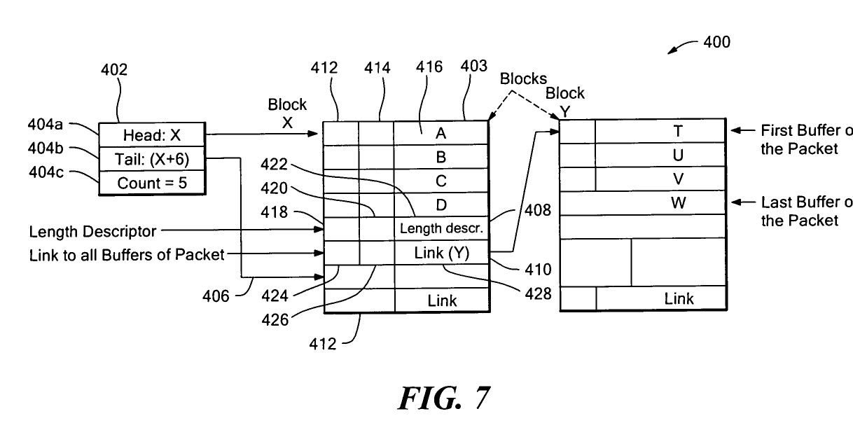

Enqueuing of a multi-buffer packet in packet mode is shown in FIG. 7. The PE that executes a multi-buffer enqueue command sends the following information to the queuing hardware:
Queue number
Packet length descriptor
   [31:30]: Mode selector,
   [29:16]: Software defined,
   [15:0]: Packet length in byte granularity
subsequent block address descriptor where all the buffer descriptors are stored.
   [31:30]: Mode selector,
   [29:21]: Software defined,
   [20:0]: block address
a new block address
   Based on the queue number, the queuing hardware reads the queuing structure 400 queue descriptor 402 (head pointer 404a, tail pointer 404b) from memory. After the queue descriptor 402 is returned, at the address 406 pointed to by the tail pointer 404b, the queuing hardware writes the received packet length descriptor 408 to external memory, e.g., block x, and in the next location writes the subsequent block address descriptor 410 pointing to the next block, e.g., blocky. These two descriptors 408, 410 are written to external memory at an aligned quad word boundary. If required, previously unaligned buffer descriptors are written to external memory with the odd location defined by a null descriptor.

In the illustrated embodiment, the buffer descriptor 403 includes a mode selector field 412 and packet length field 414 as well as the buffer pointer 416, as described above. The packet length descriptor 408 includes a mode selector field 418, a software use field 420, and a packet length field 422. The link descriptor 410 includes a mode selector field 424, a software use field 426, and a block address pointer 428.

One advantage of this scheme is that in burst-of-four memory, the length descriptor 408 and subsequent block descriptor 410 can be read in a single 64-bit access. If the tail pointer 404b is pointing to the last or penultimate location of the block, the queuing hardware uses the new block address received with the command and writes the address in the link location of the current block. The queuing hardware then writes the length descriptor 408 and subsequent block descriptor 410 in the first two locations of the newly attached block. The tail pointer 404b moves to the next location of current block (e.g., the location after subsequent block descriptor location). A signal is sent to the queuing PE to notify it that the new block supplied with the command has been used.

The buffer descriptor 403 that points to the last buffer of the packet is marked EOP. In this case, the packet is attached as a stub to the main block. Subsequent packets to this queue for enqueue return to the main block only.

To dequeue a single buffer packet in packet mode, the dequeue command specifies the queue number to the queuing hardware, which reads the queue descriptor 403 from memory for the supplied queue number. Using the head pointer 404a, the queuing hardware then launches a read of the buffer descriptor 403 indexed by the head pointer. If another dequeue command for that queue is received with a dequeue read in pipeline, the queuing hardware initiates a read for additional buffer descriptors.

When the buffer descriptor read data returns, the queuing hardware completes a dequeue of the packet by sending the returned buffer descriptor to the requesting PE and advancing the head pointer 404a to the next buffer descriptor location. Note that if the packet is found to be multi-buffer packet then a multi-buffer packet dequeue scheme is followed as set forth below. If subsequent dequeue requests are pending and pre-fetched buffer descriptors exist, they are satisfied by sending the buffer descriptors to the requesting PE and advancing the head pointer 404a. A back-to-back dequeue from the same queue works with the same efficiency as dequeue commands to different queues.

An advantage over known queuing structures is shown when performing a dequeue of a multi-buffer packet in packet mode for exemplary block-based queuing structures. The length descriptor 408 and link descriptor 410 pair for a multi-buffer packet in burst-of-4 memories are written in the current block at a quad-word aligned address. This ensures that the length descriptor 408 and link descriptor 410 pair is accessed with a single read. For a dequeue of a multi-buffer packet, the queuing hardware returns the length descriptor 408 and link descriptor 410 pair to the requesting PE.

With this arrangement, block based queuing enables back to back dequeues from the same queue at POS OC-192 rates, for example. Since multiple buffer descriptor reads can be launched in parallel, unlike linked list structures, bottlenecks are reduced or eliminated.

Other embodiments are within the scope the appended claims.

What is claimed is:

1. A data queuing system, comprising:
a first memory to contain a queue descriptor having a first pointer and a second pointer; and
a second memory having a first memory block to contain buffer descriptors having a mode field to define properties for a buffer, a segment count field to define a number of fixed-size segments for the buffer, and an address pointer field to point to the buffer,
wherein the first pointer points to a next buffer descriptor in the first memory block to be removed from the queue and the second pointer points to a next available entry in the second memory.

2. The system according to claim 1, wherein the queue descriptor further includes a count field to contain a count of a number of buffers.

3. The system according to claim 1, wherein an entry in the first memory block contains a link to a second memory block.

4. The system according to claim 3, wherein the link to the second memory block is located in a last entry in the first memory block.

5. The system according to claim 1, wherein a size of the first memory block is configurable.

6. The system according to claim 1, wherein the second pointer points to an entry in a second memory block in the second memory.

7. The system according to claim 1, wherein a multi-buffer packet includes a first queue descriptor of a plurality of queue descriptors stored in the first memory block and others of the plurality of queue descriptors for the multi-buffer packet stored in a second memory block of the second memory.

8. The system according to claim 7, wherein the first memory block contains a link to the second memory block in a location after the first queue descriptor for the multi-buffer packet.

9. The system according to claim 1, further including a packet length stored in the first memory block.

10. A network forwarding device, comprising:
at least one line card to forward data to ports of a switching fabric;
the at least one line card including a network processor having multi-threaded processing elements configured to execute microcode;
a first memory coupled to one or more of the processing elements to contain a queue descriptor having a first pointer and a second pointer; and
a second memory having a first memory block to contain buffer descriptors having a mode field to define properties for a buffer, a segment count field to define a number of fixed-size segments for the buffer, and an address pointer field to point to the buffer,
wherein the first pointer points to a next buffer descriptor in the first memory block to be removed from the queue and the second pointer points to a next available entry in the second memory.

11. The device according to claim 10, wherein the queue descriptor further includes a count field to contain a count of a number of buffers for a packet.

12. The device according to claim 10, wherein a size of the first memory block is configurable.

13. The device according to claim 10, wherein a multi-buffer packet includes a first queue descriptor of a plurality of queue descriptors stored in the first memory block and others of the plurality of queue descriptors for the multi-buffer packet stored in a second memory block of the second memory.

14. The device according to claim 10, further including a packet length stored in the first memory block.

15. A method of implementing a queuing structure, comprising:
storing a queue descriptor for a queue in a first memory, the queue descriptor having a first pointer and a second pointer;
storing at least one buffer descriptor for the first queue in a second memory having a first block, the at least one buffer descriptor having a mode field, a segment count field, and a data buffer address pointer field, wherein the first pointer points to a next queue descriptor to be removed from the queue and the second pointer points to the next available entry in the first block of the second memory.

16. The method according to claim 15, wherein the queue descriptor includes a count field.

17. The method according to claim 16, further including storing a link in the first block to a second block in the second memory.

18. The method according to claim 15, wherein a size of the first memory block is configurable.

19. The method according to claim 15, further including storing, for a multi-buffer packet, a first queue descriptor of a plurality of buffer descriptors in the first block and others of the plurality of buffer descriptors in a second block of the second memory.

20. The method according to claim 15, further including storing a packet length in the first block.
